(19) United States
(12) Patent Application Publication
(10) Pub. No.: US 2024/0219853 A1
(43) Pub. Date: Jul. 4, 2024

(54) TONER

(71) Applicant: CANON KABUSHIKI KAISHA, Tokyo (JP)

(72) Inventors: YU YOSHIDA, Shizuoka (JP); NAOYA ISONO, Shizuoka (JP); SHOTARO NOMURA, Shizuoka (JP)

(21) Appl. No.: 18/391,396

(22) Filed: Dec. 20, 2023

(30) Foreign Application Priority Data
Dec. 27, 2022 (JP) 2022-209748

(51) Int. Cl. G03G 9/087; G03G 9/097

(52) U.S. Cl. CPC G03G 9/08711; G03G 9/08755; G03G 9/09733

(57) ABSTRACT

A toner includes toner particles containing a crystalline organic material that contains a crystalline vinyl resin as an essential component and a crystalline polyester and a wax component as optional components. A total of the crystalline vinyl resin, crystalline polyester, and wax component with respect to the toner particles is 10.0 to 90.0 mass %. The crystalline vinyl resin contains a crystalline resin A having (i) units A and (ii) units B. The toner particles contain 0.0020 to 0.0500 mass % of a metal that can form a complex with an acetylacetonate moiety in a unit B of the crystalline resin A with respect to a mass of the toner particles. The acetylacetonate moiety of at least one of the units B in the crystalline resin A forms a complex with the metal. In the crystalline resin A, a content of the unit B is 0.50 to 10.0 mass %.

### BACKGROUND

### Field

The present disclosure relates to a toner used in recording methods that utilize an electrophotographic method, an electrostatic recording method, and a toner jet system recording method.

### Description of the Related Art

In recent years, in order to decrease power consumption in electrophotography, saving energy has been required in various electrophotographic processes. In a laser beam printer, the thermal energy of a fixing unit in the toner fixing process accounts for a large proportion, and there have been attempts to decrease the fixing temperature. In order to decrease the fixing temperature, it is effective to improve the low-temperature fixability of the toner. The toner is also required to exhibit storage stability (heat-resistant storage stability) for withstanding a high-temperature storage environment such as during transporting.

In order for the toner to achieve both the low-temperature fixability and the heat-resistant storage stability at high levels, according to the studies described in Japanese Patent Laid-Open No. 2015-36723, a large amount a crystalline organic material is added as a binder resin, and coatings are formed by non-crystalline shells. Moreover, Japanese Patent Laid-Open No. 2017-181576 discloses studies on improving chargeability of a toner, which contains a large amount of a crystalline polyester resin, in a low-temperature, low-humidity environment.

However, a toner coated with a shell layer such as the one disclosed in Japanese Patent Laid-Open No. 2015-36723 does not have the desired low-temperature fixability due to the obstruction caused by the shell layer when fixing is performed at a lower fixing temperature.

Meanwhile, adding a large amount of a crystalline organic material tends to degrade the charging stability at a low temperature and a low humidity and at a high temperature and a high humidity; however, it has been found that, in order to control the chargeability by using an additive, such as a surfactant, having a high anti-leaking property in a technology such as the one disclosed in Japanese Patent Laid-Open No. 2017-181576, it is difficult to stabilize the chargeability over a long period of time as printing is repeated for a long time particularly in a high-temperature, high-humidity environment (Japanese Patent Laid-Open No. 2017-67925 is discussed below).

### SUMMARY

The present disclosure provides a toner in which the low-temperature fixability, the heat-resistant storage stability, and the charging stability in both a low-temperature, low-humidity environment and a high-temperature, high-humidity environment are improved.

The present disclosure provides a toner that contains toner particles containing a crystalline organic material, in which the crystalline organic material contains a crystalline vinyl resin as an essential component, and further contains a crystalline polyester and a wax component as optional components. A total content of the crystalline vinyl resin, the crystalline polyester, and the wax component with respect to the toner particles is 10.0 mass % or more and 90.0 mass % or less. The crystalline vinyl resin contains a crystalline resin A that has (i) units A represented by formula (1) and (ii) units B represented by formula (2). The toner particles contain 0.0020 mass % or more and 0.0500 mass % or less of a metal that can form a complex with an acetylacetonate moiety in a unit B of the crystalline resin A with respect to a mass of the toner particles. The acetylacetonate moiety of at least one of the units B in the crystalline resin A forms a complex with the metal. In the crystalline resin A, a content of the unit B is 0.50 mass % or more and 10.0 mass % or less:

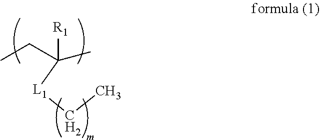

In formula (1), R₁ represents a hydrogen atom or a methyl group, L₁ represents a single bond, an ester bond, or an amide bond, and m represents an integer of 15 or more and 30 or less.

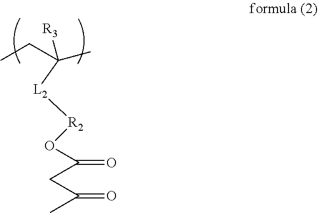

In formula (2), R₂ represents a C1-C5 alkylene group that may have a branched structure, L₂ represents a single bond, an ester bond, or an amide bond, and R₃ represents a hydrogen atom or a methyl group.

Further features of the present disclosure will become apparent from the following description of exemplary embodiments.

### DESCRIPTION OF THE EMBODIMENTS

A toner according to the present disclosure will now be described specifically. Features of the present disclosure

A toner of the present disclosure contains toner particles containing a crystalline organic material.
(I) The crystalline organic material contains a crystalline vinyl resin as an essential component, and further contains a crystalline polyester and a wax component as optional components, and the total content of the crystalline vinyl resin, the crystalline polyester, and the wax component with respect to the toner particles is 10.0 mass % or more and 90.0 mass % or less.
(II) The crystalline vinyl resin contains a crystalline resin A that has:
   (i) units A represented by formula (1) below and
   (ii) units B represented by formula (2) below.

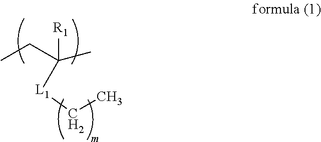

In formula (1), R₁ represents a hydrogen atom or a methyl group, L₁ represents a single bond, an ester bond, or an amide bond, and m represents an integer of 15 or more and 30 or less.

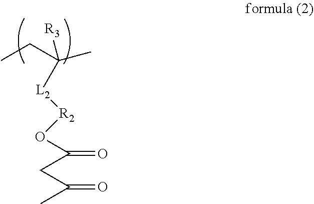

In formula (2), R₂ represents a C1-C5 alkylene group that may have a branched structure, L₂ represents a single bond, an ester bond, or an amide bond, and R₃ represents a hydrogen atom or a methyl group.
(III) The toner particles contain 0.0020 mass % or more and 0.0500 mass % or less of a metal that can form a complex with an acetylacetonate moiety in the unit B of the crystalline resin A with respect to a mass of the toner particles, and the acetylacetonate moiety of at least one of the unit B in the crystalline resin A forms a complex with the metal.
(IV) In the crystalline resin A, a content of the units B is 0.50 mass % or more and 10.0 mass % or less.

It should be noted that the phrase “the crystalline organic material contains a crystalline vinyl resin as an essential component, and further contains a crystalline polyester and a wax component as optional components” means that the crystalline vinyl resin must be contained in the crystalline organic material whereas the crystalline polyester and the wax component do not have to be contained in the crystalline organic material.

The toner of the present disclosure, which contains the crystalline organic material, exhibits a sharp heat-melting characteristic, and thus the low-temperature fixing performance can be improved. In general, the state of crystallization (crystallinity) of a crystalline organic material varies depending on the composition, the production method, whether heat annealing is conducted, etc. When crystallization is insufficient, the amorphous component tends to have a low glass transition point (Tg), and thus the over-time storage stability (heat-resistant storage stability) of the toner under heat tends to be degraded. An example of the method for further increasing the crystallinity is to use a site where crystallization starts (a nucleation site or a nucleation agent) and a crystalline organic material in combination. Since the crystalline resin A of the present disclosure has the units A, long-chain alkyl units line up, and crystallization can be achieved. Moreover, since at least one of the units B contains a metal, crystallization of the units A can be promoted, and the crystalline resin A can act as a nucleation agent. The reason for this and the more detailed mechanism therefor are as follows.

When the acetylacetonate moiety of at least one of the units B in the crystalline resin A forms a complex with the metal, a driving force is generated, making it easy for the metal of one polymer chain to come close to an acetylacetonate moiety of another polymer chain through coordination bonding. Thus, since the polymer chains easily come close to each other in the toner, the units A incorporated in the same polymer chains crystallize easily. Thus, the crystalline resin A itself is expected to easily form polymer aggregates (nuclei) that have been highly crystallized in the toner.

It is considered that since this acts as a nucleation agent, the crystallization of the organic crystalline material is promoted. Presumably as a result, the heat-resistant storage stability of the toner of the present disclosure is improved.

Meanwhile, when the unit B of the present disclosure and the metal form a complex, an appropriate degree of anti-leaking property is imparted. Thus, a notable charge-up can be reduced particularly in a low-temperature, low-humidity (LL) environment. Furthermore, since no acid-dissociable functional groups are contained and moisture absorption can be reduced, good chargeability can be exhibited in a high-temperature, high-humidity (HH) environment. As a result, stable chargeability can be exhibited and image defects can be reduced in various environments ranging from a high-temperature, high-humidity (HH) environment to a low-temperature, low-humidity (LL) environment.

Note that it has been practiced in the past to control the chargeability by introducing, into the toner, a metal and a low-molecular-weight compound having an acetoacetoxy structure the same as that in the unit B (for example, see Japanese Patent Laid-Open No. 2017-67925). However, a person skilled in the art cannot predict an effect that, by introducing a moiety, such as the unit B, capable of coordinating with a metal into a crystalline material (crystalline resin A), such as the one provided by the present disclosure, and using a metal in combination therewith, the crystalline material is used as a nucleation agent for promoting crystallization.

Regarding constituent materials of the present disclosure

The materials of the present disclosure will now be specifically described.

### Crystalline Organic Material

In the present disclosure, “crystalline” used in such expressions as crystalline resins and crystalline organic materials refers to a resin or an organic material that has a clear endothermic peak (melting point) in differential scanning calorimetry (DSC).

The crystalline organic material in the present disclosure is a high-molecular-weight or low-molecular weight organic compound having a melting point. The crystalline organic material of the present disclosure may contain elements other than organic elements. For the electrophotographic toner usage, a material with a melting point of 250° C. or lower can be used from the viewpoint of fixability to paper.

The crystalline organic material contains a crystalline vinyl resin as an essential component, and may further contain a crystalline polyester and a wax component as optional components. When these components are contained, the low-temperature fixability is easily improved. The wax in the present disclosure refers to a compound having a weight-average molecular weight of 3000 or less in the crystalline organic material.

The crystalline organic material of the present disclosure features that the total content of the crystalline vinyl resin, the crystalline polyester, and the wax component with respect to the toner particles is 10.0 mass % or more and 90.0 mass % or less. At a total content of 10.0 mass % or more, the low-temperature fixability can be improved. At a total content of 90.0 mass % or less, degradation of heat-resistant storage stability, which is the disadvantage of the aforementioned crystalline resin, can be reduced. More preferably, the total content is 30.0 mass % or more and 70.0 mass % or less.

An ester wax may be contained as the wax component, which is an optional component in the crystalline organic material of the present disclosure. An ester wax generally has a plasticizing effect for amorphous resins. When an ester wax is contained, the following requirements may be satisfied in order to enhance the plasticizing effect during the toner melting. That is, an amorphous resin C may be contained, the amorphous resin C may be a styrene acrylic resin or a polyester resin, and the content of the ester wax in the crystalline organic material may be 70.0 mass % or more. A known material can be used as the ester wax.

The ester wax may be any as long as there is at least one ester bond in one molecule, and may be a natural ester wax or a synthetic ester wax Examples of the ester wax include, but are not limited to, the followings:
esters of a monohydric alcohol and a monocarboxylic acid, such as behenyl behenate, stearyl stearate, and palmityl palmitate;
esters of a dicarboxylic acid and a monoalcohol such as dibehenyl sebacate;
esters of a dihydric alcohol and a monocarboxylic acid such as ethylene glycol distearate and hexanediol dibehenate;
esters of a trihydric alcohol and a monocarboxylic acid such as glyceryl tribehenate;
esters of a tetrahydric alcohol and a monocarboxylic acid such as pentaerythritol tetrastearate and pentaerythritol tetrapalmitate;
esters of a hexahydric alcohol and a monocarboxylic acid such as dipentaerythritol hexastearate, dipentaerythritol hexapalmitate, and dipentaerythritol hexabehenate;
esters of a polyhydric alcohol and a monocarboxylic acid such as polyglyceryl behenate; and
natural ester waxes such as carnauba wax and rice wax.

Among these, ethylene glycol distearate is preferable from the viewpoint of the plasticizing effect.

The crystalline polyester, which is another optional component in the crystalline organic material of the present disclosure, can be obtained by condensation polymerization of a polycarboxylic acid and a polyhydric alcohol, and, in particular, a polymer having a melting point can be used. For example, following monomers can be used. Examples of the polycarboxylic acid include the following compounds: dibasic acids such as succinic acid, adipic acid, sebacic acid, phthalic acid, isophthalic acid, terephthalic acid, malonic acid, and dodecenylsuccinic acid, anhydrides thereof, lower alkyl esters thereof, and aliphatic unsaturated dicarboxylic acids such as maleic acid, fumaric acid, itaconic acid, and citraconic acid; and

1,2,4-benzenetricarboxylic acid, 1,2,5-benzenetricarboxylic acid, anhydrides thereof, and lower alkyl esters thereof. These compounds may be used alone or in combination.

Examples of the polyhydric alcohol include the following compounds: alkylene glycol (ethylene glycol, 1,2-propylene glycol, and 1,3-propylene glycol); alkylene ether glycols (polyethylene glycol and polypropylene glycol); cycloaliphatic diols (1,4-cyclohexanedimethanol); bisphenols (bisphenol A); alkylene oxide (ethylene oxide and propylene oxide) adducts of alicyclic diols. The alkyl moieties of the alkylene glycol and the alkylene ether glycol may be linear or branched.

Other examples include glycerin, trimethylolethane, trimethylolpropane, and pentaerythritol. These compounds may be used alone or in combination.

Note that, for the purposes of adjusting an acid value and a hydroxyl value, a monovalent acid, such as acetic acid and a benzoic acid, and a monohydric alcohol such as cyclohexanol and benzyl alcohol can be used as necessary.

The method for producing the polyester resin is not particularly limited, and, for example, a transesterification method and a direct condensation polymerization method can be employed alone or in combination.

For the purposes of improving the releasability, the organic crystalline material of the present disclosure may contain a hydrocarbon wax. The content of the release agent in the toner particles in the toner is preferably 1.0 mass % or more and 30.0 mass % or less and more preferably 2.0 mass % or more and 25.0 mass % or less. When the content of the release agent in the toner particles is within the aforementioned range, releasability during fixing is more reliably obtained. The melting point of the release agent can be 60° C. or higher and 120° C. or lower. When the melting point of the release agent is within the aforementioned range, the release agent easily melts and bleeds out onto the toner particle surface during fixing, and the releasability is easily exhibited. The melting point is more preferably 70° C. or higher and 100° C. or lower. Examples of the hydrocarbon wax that can be used include aliphatic hydrocarbon waxes such as low-molecular-weight polyethylene, low-molecular-weight polypropylene, low-molecular-weight olefin copolymers, Fischer-Tropsch waxes, and waxes obtained from these by oxidation or acid addition.

In the crystalline organic material, a crystalline resin B satisfying the conditions below can be contained in the crystalline vinyl resin in addition to the crystalline resin A having the aforementioned features:
The weight-average molecular weight (Mw) is 5000 or more and 50000 or less.
The content of the units A represented by formula (1) above is 40.0 mass % or more and 90.0 mass % or less.
The content of the units B is less than 0.50 mass %.

The crystalline resin B can be contained in an amount of 80.0 mass % or more. When these requirements are satisfied, the low-temperature fixability, the heat-resistant storage stability, and the charging stability in a HH environment can be improved.

When the weight-average molecular weight (Mw) of the crystalline resin B is 5000 or more, the amount of the low-molecular-weight components is small and thus the heat-resistant storage stability can be easily improved. When the Mw is 50000 or less, the resin easily wets and spreads during fixing, and thus the low-temperature fixability tends to be improved. When the unit A content in the crystalline resin B is 40.0 mass % or more and 90.0 mass % or less, the crystallinity is maintained at a high level, the amount of crystals in the polymer increases, and thus the low-temperature fixability and the heat-resistant storage stability are easily simultaneously achieved. The unit A content is more preferably 60.0 mass % or more and 90.0 mass % or less. When a crystalline resin B containing less than 0.50 mass % of the units B is contained in an amount of 80 mass % or more, the hygroscopic property in the HH environment can be reduced, and the charging stability can be improved.

### Crystalline Resin A

The crystalline resin A of the present disclosure will now be further described.

The crystalline vinyl resin of the present disclosure contains a crystalline resin A that contains (i) units A represented by formula (1) above and (ii) units B represented by formula (2), the toner particles contain 0.0020 mass % or more and 0.0500 mass % or less of a metal that can form a complex in an acetylacetonate moiety in the unit B of the crystalline resin A with respect to the mass of the toner particles, the acetylacetonate moiety of at least one of the units B in the crystalline resin A forms a complex with the metal, and in the crystalline resin A, a content of the units B is 0.50 mass % or more and 10.0 mass % or less.

As described above, when these requirements are satisfied, the heat-resistant storage stability and the charging stability are improved.

### “Units B”:

When the unit B content in the crystalline resin A is 0.50 mass % or more, the aforementioned effects are easily obtained, and the heat-resistant storage stability and the charging stability can be improved. At a content of 10.0 mass % or less, the hygroscopic property in the HH environment can be reduced, and thus the charging stability is easily improved.

Here, the acetylacetonate moiety in the unit B exhibits a keto-enol tautomerism and can form a complex with a metal such as the one represented by formula (3), for example.

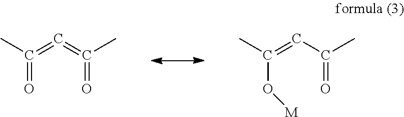

(In formula (3), M represents a metal element.)

An example of the method for introducing the units B into a crystalline resin A is to copolymerize the following monomers:
acetoacetoxyethyl (meth)acrylate, 2-acetoacetoxypropyl (meth)acrylate, acetoacetoxybutyl (meth)acrylate, 2-[(1-oxo-2-propen-1-yl)amino]ethyl 3-oxobutanoate, and 4-[(1-oxo-2-propen-1-yl)amino]butyl 3-oxobutanoate.

When R₂ in formula (2) of the unit B has 1 or more and 5 or less carbon atoms, the distance to the polymer main chain is short, and thus the nucleating effect is easily exhibited. More preferably, the number of carbon atoms is 2 or more and 4 or less.

When L₂ is an ester bond, the charging stability in the HH environment is easily improved.

### “Units A”:

The unit A content in the crystalline resin A can be 40.0 mass % or more and 90.0 mass % or less. At a content of 40.0 mass % or more, the crystallinity tends to be high, and thus the heat-resistant storage stability is easily improved. At a content of 90.0 mass % or less, the nucleation sites tend to become finer in the toner particles, and thus the heat-resistant storage stability is also easily improved. Preferably, the unit A content is 60.0 mass % or more and 80.0 mass % or less.

When m in formula (1) of the unit A is 15 or more and 30 or less, a long-chain alkyl group is present, and the resin easily exhibits crystallinity due to the presence of the long-chain alkyl group. Here, m is preferably 17 or more and 23 or less and more preferably 19 or more and 23 or less.

An example of the method for introducing the units A into the crystalline resin A is to polymerize (meth)acrylic acid esters such as those described below: (meth)acrylic acid esters having C16-C36 linear alkyl groups [e.g., stearyl (meth)acrylate, nonadecyl (meth)acrylate, eicosyl (meth)acrylate, heneicosanyl (meth)acrylate, behenyl (meth)acrylate, lignoceryl (meth)acrylate, ceryl (meth)acrylate, octacosyl (meth)acrylate, myricyl (meth)acrylate, and dotriacontyl (meth)acrylate] and (meth)acrylic acid esters having C18-C36 branched alkyl groups [e.g., 2-decyltetradecyl (meth)acrylate]. The monomers forming the units A may be used alone or in combination.

### “Other Units”:

In the crystalline resin A, in addition to the monomers that can form the units A and the units B, monomers that can form other units indicated below may be copolymerized:
(meth)acrylic acid esters such as styrene, α-methylstyrene, methyl (meth)acrylate, ethyl (meth)acrylate, n-butyl (meth)acrylate, t-butyl (meth)acrylate, and 2-ethylhexyl (meth)acrylate;
urea group-containing monomers, for example, monomers obtained by reacting a C3-C22 amine [primary amines (n-butylamine, t-butylamine, propylamine, isopropylamine, etc.) and secondary amines (di-n-ethylamine, di-n-propylamine, di-n-butylamine, etc.)] and a C2-C30 isocyanate having an ethylenically unsaturated bond by a known method;
carboxy group-containing monomers, for example, methacrylic acid, acrylic acid, and 2-carboxyethyl (meth)acrylate;
hydroxy group-containing monomers, for example, 2-hydroxyethyl (meth)acrylate and 2-hydroxypropyl (meth)acrylate;
amide group-containing monomers, for example, monomers obtained by reacting acrylamide, a C1-C30 amine, and a C2-C30 carboxylic acid having an ethylenically unsaturated bond (acrylic acid, a methacrylic acid, etc.) by a known method; and
nitrile group-containing monomers, for example, acrylonitrile and methacrylonitrile.

Among these, styrene, methacrylic acid, acrylic acid, methyl (meth)acrylate, t-butyl (meth)acrylate, acrylonitrile, or methacrylonitrile may be used.

### “Physical Properties of Crystalline Resin A”:

The crystalline resin A can have a melting point of 55.0° C. or higher and 70.0° C. or lower.

When the melting point is 70.0° C. or lower, melting occurs at a lower temperature, and thus the low-temperature fixability tends to be improved. When the melting point is 55.0° C. or higher, the heat-resistant storage stability is easily improved. The melting point is more preferably 58.0° C. or higher and 68.0° ° C. or lower. The melting point of the crystalline resin A can be controlled by changing the amount of the units A and the number of carbon atoms, m, in the units A.

The crystalline resin A can have an acid value (Av) and a hydroxyl value (OHv) of 5.0 mgKOH/g or less each. At 5.0 mgKOH/g or less, the hygroscopic property in the HH environment can be reduced, and thus the charging stability is easily improved. An example of the method for controlling the acid value is to copolymerize a polymer having an acid group, such as acrylic acid. An example of the method for controlling the hydroxyl value is to copolymerize a monomer having a hydroxyl group, such as 2-hydroxyethyl methacrylate.

The crystalline resin A content in the crystalline organic material can be 1.0 mass % or more and 70.0 mass % or less. When the content is 1.0 mass % or more, the effect as a nucleation agent is easily obtained. When the content is 70.0 mass % or less, leaking in the HH environment can be easily reduced, and thus the charging stability is easily improved. More preferably, the content is 5.0 mass % or more and 30.0 mass % or less.

From the viewpoint of achieving both the low-temperature fixability and the heat-resistant storage stability, the weight-average molecular weight (Mw) of the THF-soluble matter in the crystalline resin A can be 10000 or more and 50000 or less.

A known polymerization initiator can be used as the polymerization initiator for obtaining the crystalline vinyl resin of the present disclosure.

Examples thereof include azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile; and peroxide polymerization initiators such as benzoyl peroxide, t-butyl peroxy 2-ethylhexanoate, t-butyl peroxypivalate, t-butyl peroxyisobutyrate, t-butyl peroxyneodecanoate, methyl ethyl ketone peroxide, diisopropyl peroxycarbonate, cumene hydroperoxide, 2,4-dichlorobenzoyl peroxide, and lauroyl peroxide. Known chain transfer agents and polymerization inhibitors can also be used.

“Metal that can Form a Complex with a Unit B”:

When the content of the metal that can form a complex with the acetylacetonate moiety in the unit B of the crystalline resin A with respect to the mass of the toner particles is 0.0020 mass % or more, the complex-forming efficiency is improved, and thus the heat-resistant storage stability and the charging stability in the LL environment are easily improved. When this content is 0.0500 mass % or less, charge leaking in the HH environment can be reduced, and thus the charging stability in the HH environment is easily improved. The metal content is more preferably 0.0100 mass % or more and 0.0400 mass % or less.

The metal to be bonded to the unit B may be any metal that can coordinate to the unit B, and can be one of Al, Zn, Fe, Cu, Co, Ni, Ti, Mg, and Mn. The use of those metals increases the effect as a nucleation agent and tends to improve the heat-resistant storage stability. More preferably, the metal is Al, Zn, Fe, Co, Ti, Mg, or Mn, and yet more preferably the metal is aluminum. The unit B may form any complex with respect to these metals. Metal compounds used to introduce these metals into the toner may take any form; however, for more effective introduction into the toner, an oil-soluble metal compound can be used. Examples of the oil-soluble metal compound that can be used include metal compounds represented by formula (4).

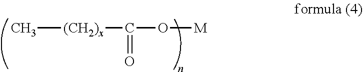

(In formula (4), M represents a metal element, x represents an integer of 2 or more and 17 or less, and n represents an integer of 1 or more and 3 or less.)

Specific examples of the metal compound represented by formula (4) above include aluminum laurate (M=Al, x=10, n=3), aluminum distearate (M=Al, x=16, n=2), cobalt distearate (M=Co, x=16, n=2), magnesium distearate (M=Mg, x=16, n=2), and iron tristearate (M=Fe, x=16, n=3).

### Colorant

The toner may contain a colorant. Examples of the colorant include known organic pigments, organic dyes, inorganic pigments, and carbon black serving as black colorants. In addition, colorants that have been used in toners in related art may be used.

Examples of the yellow colorant are as follows: condensed azo compounds, isoindolinone compounds, anthraquinone compounds, azo metal complexes, methine compounds, and allylamide compounds. Specifically, C.I. Pigment Yellow 12, 13, 14, 15, 17, 62, 74, 83, 93, 94, 95, 109, 110, 111, 128, 129, 147, 150, 155, 168, and 180 can be used.

Examples of the magenta colorant are as follows: condensed azo compounds, diketopyrrolopyrrole compounds, anthraquinone compounds, quinacridone compounds, basic dye lake compounds, naphthol compounds, benzimidazolone compounds, thioindigo compounds, and perylene compounds.

Specifically, C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, 236, and 254 can be used.

Examples of the cyan colorant are as follows: copper phthalocyanine compounds and derivatives thereof, anthraquinone compounds, and basic dye lake compounds. Specifically, C.I. Pigment Blue 1, 7, 15, 15:1, 15:2, 15:3, 15:4, 60, 62, and 66 can be used.

The colorant is selected from the viewpoints of the hue angle, the color saturation, the lightness value, the light fastness, and the dispersibility in the toner.

The colorant content can be 3.0 mass % or more and 20.0 mass % or less in the toner particles.

### External Additive

The toner particles may be directly used as the toner or may be mixed with an external additive and the like as necessary to have the external additive attach to the toner particle surfaces to form a toner.

Examples of the external additive include inorganic fine particles selected from silica fine particles, alumina fine particles, and titania fine particles, and complex oxides thereof. Examples of the complex oxides include silica aluminum fine particles and strontium titanate fine particles.

The external additive content relative to 100 parts by mass of the toner particles is preferably 0.01 parts by mass or more and 8.0 parts by mass or less and more preferably 0.1 parts by mass or more and 4.0 parts by mass or less.

### Toner Production Method

Toner particles may be produced by any known method, such as a suspension polymerization method, an emulsion aggregation method, a dissolution suspension method, or a pulverization method, but is preferably produced by a suspension polymerization method.

The suspension polymerization method is described in detail.

For example, a polymerizable monomer composition is prepared by mixing and then homogeneously dissolving or dispersing a crystalline resin A, and, if necessary, a crystalline resin B, a crystalline polyester, a wax, an amorphous resin C or polymerizable monomers that form the amorphous resin C, a colorant, a release agent, a charge control agent, and other materials.

Subsequently, the polymerizable monomer composition is dispersed in an aqueous medium by using a stirrer or the like to prepare suspended particles of the polymerizable monomer composition. Then the polymerizable monomers contained in these particles are polymerized by using an initiator or the like to obtain toner particles.

Upon completion of the polymerization, the toner particles are filtered, washed, and dried by known methods, and, if necessary, an external additive is added thereto to obtain a toner.

Examples of the polymerization initiator are the same as the polymerization initiators for obtaining the crystalline vinyl resin described above. Known chain transfer agents and polymerization inhibitors can also be used.

The aqueous medium may contain an inorganic or organic dispersion stabilizer. A known dispersion stabilizer can be used as the dispersion stabilizer.

Examples of the inorganic dispersion stabilizer include phosphates such as hydroxyapatite, tricalcium phosphate, dicalcium phosphate, magnesium phosphate, aluminum phosphate, and zinc phosphate; carbonates such as calcium carbonate and magnesium carbonate; metal hydroxides such as calcium hydroxide, magnesium hydroxide, and aluminum hydroxide; sulfates such as calcium sulfate and barium sulfate; calcium metasilicate; bentonite; silica; and alumina.

Examples of the organic dispersion stabilizer include polyvinyl alcohol, gelatin, methylcellulose, methylhydroxypropylcellulose, ethylcellulose, sodium salts of carboxymethylcellulose, polyacrylic acid and salts thereof, and starch.

When an inorganic compound is used as the dispersion stabilizer, a commercially available dispersion stabilizer may be directly used, or, in order to obtain finer particles, this inorganic compound may be generated in an aqueous medium and used. For example, in the case of calcium phosphates such as hydroxyapatite and tricalcium phosphate, an aqueous phosphate solution and an aqueous calcium salt solution may be mixed under rigorous stirring.

The aqueous medium may contain a surfactant. A known surfactant can be used as the surfactant. Examples thereof include anionic surfactants such as sodium dodecylbenzene sulfate and sodium oleate; cationic surfactants; amphoteric surfactants; and nonionic surfactants.

Meanwhile, the toner production method by a pulverization method is not particularly limited and, for example, can contain a step of melt-kneading raw materials that contain the crystalline resin A, the amorphous resin C, and, if necessary, a colorant, a release agent, etc., and a step of obtaining toner particles by pulverizing the obtained melt-kneaded product. A known apparatus may be employed in the melt-kneading and pulverizing.

### Method for Measuring Physical Properties

Methods for measuring the physical properties of the toner will now be described.

Method for measuring weight average particle diameter (D4) of toner particles and toner

The weight average particle diameters (D4) of the toner particles and the toner are measured by using a precision particle size analyzer “Coulter Counter Multisizer 3” (registered trademark, produced by Beckman Coulter, Inc.). The conditions for the measurement are as follows.
Number of effective measuring channel: 25,000 channels
Total number of control motors: 50000
Aperture: 100 μm
Current: 1600 μA
Gain: 2

The Kd value is measured with a value obtained by using “standard particles 10.0 μm” (produced by Beckman Coulter, Inc.). The measurement data is analyzed with a packaged dedicated software to calculate the weight average particle diameter (D4). Here, the weight average particle diameter (D4) is the “average diameter” in the “analysis/volume statistical value (arithmetic means)” screen when the dedicated software is set to graph/vol %.

### Method for Measuring Molecular Weight (Mw) of THF-Soluble Matter

The molecular weight (weight-average molecular weight Mw) of the THF-soluble matter of the toner is measured by gel permeation chromatography (GPC) as follows.

First, the toner is dissolved in tetrahydrofuran (THF) at 50° C. over a period of 2 hours. The obtained solution is filtered through a solvent-resistant membrane filter “Maishori Disk” (produced by Tosoh Corporation) having a pore diameter of 0.2 μm to obtain a sample solution. The sample solution is adjusted so that the concentration of the components soluble in THF is 0.8 mass %. Measurement is performed on this sample solution under the following conditions.
Instrument: HLC8120 GPC (detector: RI) (produced by Tosoh Corporation)
Columns: seven columns, Shodex KF-801, 802, 803, 804, 805, 806, and 807 (produced by Showa Denko K.K.)
Eluent: tetrahydrofuran (THF)
Flow rate: 1.0 mL/min
Oven temperature: 40.0° ° C.
Sample injection amount: 0.10 mL

The molecular weight of a sample is calculated by using a molecular weight calibration curve plotted by using standard polystyrene resins (for example, trade name “TSK standard polystyrene F-850, F-450, F-288, F-128, F-80, F-40, F-20, F-10, F-4, F-2, F-1, A-5000, A-2500, A-1000, and A-500” produced by Tosoh Corporation).

Method for Isolating Crystalline Resin a and Crystalline Polyester from Toner

Isolation of the crystalline resin A and the crystalline polyester from the toner is possible by a known method, and one example thereof is described below.

A method for isolating a resin component from a toner involves using gradient LC. In this analysis, isolation according to the polarity of the resin in the binder resin is possible irrespective of the molecular weight.

First, a toner is dissolved in chloroform. A sample is adjusted with chloroform so that the sample concentration is 0.1 mass %, and the resulting solution is filtered through a 0.45 μm PTFE filter and subjected to the measurement. The gradient polymer LC measurement conditions are as follows.
Instrument: UltiMate 3000 (produced by Thermo Fisher Scientific)
Mobile phase: A: chloroform (HPLC), B: acetonitrile (HPLC)
Gradient: 2 min (A/B=0/100)→25 min (A/B=100/0) (here, the gradient of changes in the mobile phase is adjusted to be linear)
Flow rate: 1.0 mL/min
Injection: 0.1 mass %×20 μL
Column: Tosoh TSKgel ODS (4.6 mmϕ×150 mm×5 μm)
Column temperature: 40° ° C.
Detector: Corona charged aerosol detector (Corona-CAD)(produced by Thermo Fisher Scientific)

Peak detection positions are specified from a time-intensity graph obtained by the measurement, and the peak position fractionation is performed during next measurement by using a fraction collector or the like. The fractionated resin is subjected to DSC measurement, and resins having a melting point are assumed to be a crystalline resin A and a crystalline polyester. The fractionated resin having a melting point is subjected to the NMR measurement to identify the type of resin.

Method for Isolating Wax from Toner

When a wax is contained in the toner, the release agent needs to be isolated from the toner.

Isolation of the release agent is performed by recycle HPLC, and components having a molecular weight of 3000 or less are isolated as the release agent. The measurement method is as follows. First, a chloroform solution of the toner is prepared as described above. The obtained solution is filtered through a solvent-resistant membrane filter “Maishori Disk” (produced by Tosoh Corporation) having a pore diameter of 0.2 μm to obtain a sample solution. The sample solution is adjusted so that the concentration of the components soluble in chloroform is 1.0 mass %. Measurement is performed on this sample solution under the following conditions.
Instrument: LC-Sakura NEXT (produced by Japan Analytical Industry Co., Ltd.)
Column: JAIGEL2H, 4H (produced by Japan Analytical Industry Co., Ltd.)
Eluent: chloroform
Flow rate: 10.0 mL/min
Oven temperature: 40.0° ° C.
Sample injection amount: 1.0 mL

The molecular weight of a sample is calculated by using a molecular weight calibration curve plotted by using standard polystyrene resins (for example, trade name “TSK standard polystyrene F-850, F-450, F-288, F-128, F-80, F-40, F-20, F-10, F-4, F-2, F-1, A-5000, A-2500, A-1000, and A-500” produced by Tosoh Corporation).

Components having a molecular weight of 3000 or less are collected on the basis of the molecular weight curve obtained as above. The obtained components are subjected to DSC, and those having a melting point are assumed to be the wax.

### Method for Measuring Melting Point of Crystalline Resin A

The melting point of the crystalline resin A is measured under the following conditions by using DSC Q2000 (produced by TA Instruments).
Temperature elevation rate: 10° C./min
Measurement start temperature: 20° ° C.
Measurement end temperature: 180° C.

The temperature correction of the instrument detecting unit is done by using the melting points of indium and zinc, and the heat quantity correction is done by using the heat of fusion of indium.

Specifically, a sample is accurately weighed to 5 mg, placed in an aluminum pan, and subjected to differential scanning calorimetry. An empty silver pan is used as a reference. As the temperature elevation process, the temperature is elevated at a rate of 10° C./min up to 180° C. Then the peak temperatures are calculated from the peaks and assumed to be the melting points.

### Methods for Identifying Resin Type and Determining Unit a Content and Unit B Content

The contents of various monomer units in the resins are measured by 1H-NMR under the following conditions.
Measuring instrument: FT NMR spectrometer, JNM-EX400 (produced by JEOL Ltd.)
Measurement frequency: 400 MHZ
Pulse condition: 5.0 μs
Frequency range: 10500 Hz
Number of runs: 64
Measurement temperature: 30° C.
Sample: A measurement sample (50 mg) is placed in a sample tube having an inner diameter of 5 mm, deuterated chloroform (CDCl₃) is added thereto as a solvent, and the sample is dissolved therein in a 40° C. constant-temperature oven.

The obtained 1H-NMR chart is analyzed to identify the structure of each of the monomer units. Here, as one example, the measurement of the unit A content and the unit B content in the crystalline resin A is described. From the peaks assigned to the structural features of the units A and the units B in the obtained 1H-NMR chart, a peak independent from the peaks assigned to the structural features of other monomer units is selected, and an integral value S1 of this peak is calculated. The integral value is calculated in the same manner for other monomer units contained in the crystalline resin A.

When polymerizable monomers not containing hydrogen atoms are used in the structural features other than the vinyl groups, ¹³C-NMR is employed with ¹³C as the measurement atomic nucleus in a single pass mode, followed by the calculation as in ¹H-NMR. The ratio (mol %) of each monomer unit calculated by the aforementioned method is multiplied by the molecular weight of the monomer unit to convert the monomer unit content into mass %.

### Method for Determining Amount of Metal in Toner Particles

The amount of metal in the toner is measured by fluorescence X-ray and determined by a calibration curve method. The fluorescence X-ray is measured in accordance with JIS K 0119-1969, specifically, as follows.

As the measuring instrument, a wavelength dispersive fluorescence X-ray analyzer “Axios” (produced by PANalytical) and packaged software “SuperQ ver. 4.0 F” (produced by PANalytical) for measurement condition setting and measurement data analysis are used. Rh is used as the anode of the X-ray tube, the measurement atmosphere is vacuum, and the measurement diameter (collimator mask diameter) is set to 27 mm. To measure light elements, a proportional counter (PC) is used, and to measure heavy elements, a scintillation counter SC) is used for detection. During the measurement, the acceleration voltage and the current value of the X-ray generator are respectively set to 24 kV and 100 mA.

First, pellets for plotting a calibration curve for determining the metal content in the toner are prepared. To 100 parts by mass of a binder [trade name: Spectro Blend, components: C: 81.0, O: 2.9, H: 13.5, N: 2.6 (mass %), chemical formula: C19H38ON, form: powder (44 μm); produced by Rigaku Corporation], 1.0 mass ppm of a metal compound whose metal content is known is added. The resulting mixture is thoroughly mixed with a coffee mill, and 4 g of the mixture is placed in a dedicated aluminum ring for pressing, and leveled. Next, the mixture is pressed at 20 MPa for 60 seconds using a pelletizer “BRE-32” (Maekawa Testing Machine MFG. CO., LTD.) to prepare pellets having a thickness of 2 mm and a diameter of 39 mm. In the same manner, mixtures respectively containing 10.0 mass ppm, 50.0 mass ppm, 200.0 mass ppm, and 500.0 mass ppm of a metal compound whose content is known are pelletized.

Then a calibration curve of linear function is obtained with respect to the vertical axis indicating the X-ray count and the horizontal axis indicating the added aluminum concentration calculated from the amount of aluminum hydroxide added in each of the samples for plotting a calibration curve.

The toner particles are pelletized and measured under the same conditions, and the amount of metal element is determined on the basis of the prepared calibration curve.

Method for Confirming Metal that has Formed Complex with Acetylacetonate Moiety of Unit B

The isolated crystalline resin A obtained by the aforementioned crystalline resin A isolation method is recovered, and measured by the same method as the method for determining the amount of metal in the toner particles so as to identify the metal species.

### Method for Measuring Acid Value of Resin

An acid value is the weight (mg) of potassium hydroxide necessary for neutralizing the acid contained in 1 g of a sample. The acid value of the resin A in the present disclosure is measured in accordance with JIS K 0070-1992, specifically, by the following procedure.

### (1) Preparation of Reagent

In 90 mL of ethyl alcohol (95 vol %), 1.0 g of phenolphthalein is dissolved, and deionized water is added thereto to adjust the volume to 100 mL so as to obtain a phenolphthalein solution.

In 5 mL of water, 7 g of guaranteed reagent potassium hydroxide is dissolved, and ethyl alcohol (95 vol %) is added thereto to adjust the volume to 1 L. The resulting solution is placed in an alkali-resistant container to prevent contact with carbon dioxide etc., left standing for 3 days, and filtered to obtain a potassium hydroxide solution. The obtained potassium hydroxide solution is stored in an alkali-resistant container. The factor of the potassium hydroxide solution is determined by placing 25 mL of a 0.1 mol/L hydrochloric acid in an Erlenmeyer flask, adding thereto several drops of the aforementioned phenolphthalein solution, performing titration with the aforementioned potassium hydroxide solution, and determining the factor from the amount of the potassium hydroxide solution used for neutralization. The aforementioned 0.1 mol/L hydrochloric acid is prepared in accordance with JIS K 8001-1998.

### (2) Procedure

### (A) Main Test

Into a 200 mL Erlenmeyer flask, 2.0 g of the toner sample melt-kneaded and pulverized is accurately weighed, 100 mL of a toluene/ethanol (2:1) mixed solution is added thereto, and the sample is dissolved therein over a period of 5 hours. Next, several drops of the phenolphthalein solution described above is added as an indicator, and titration is performed by using the aforementioned potassium hydroxide solution. The end point of the titration is when the pinkish color of the indicator continues for 30 seconds.

### (B) Blank Test

Titration is performed as described above except that no sample is used (in other words, only the toluene/ethanol (2:1) mixed solution is used).

(3) The obtained result is substituted into the following equation to calculate the acid value.

$$A = [ ( C - B ) \times f \times 5.61 ] / S$$

Here, A: acid value (mgKOH/g), B: amount of potassium hydroxide solution added (mL) in blank test, C: amount of potassium hydroxide solution added (mL) in main test, f: factor of potassium hydroxide solution, S: sample (g).

### Method for Measuring Hydroxyl Value

A hydroxyl value is the number of milligrams of potassium hydroxide necessary for neutralizing the acetic acid bonded to hydroxyl groups when 1 g of a sample is acetylated. The hydroxyl value of the binder resin is measured in accordance with JIS K 0070-1992, specifically, by the following procedure.

### (1) Preparation of Reagent

Into a 100 mL measuring flask, 25 g of guaranteed reagent acetic anhydride is placed, pyridine is added thereto to adjust the total amount to 100 mL, and the resulting mixture is thoroughly shaken to obtain an acetylated reagent. The obtained acetylated reagent is stored in a brown bottle so as to prevent contacting moisture, carbon dioxide, etc.

In 90 mL of ethyl alcohol (95 vol %), 1.0 g of phenolphthalein is dissolved, and deionized water is added thereto to adjust the volume to 100 mL so as to obtain a phenolphthalein solution.

In 20 mL of water, 35 g of guaranteed reagent potassium hydroxide is dissolved, and ethyl alcohol (95 vol %) is added thereto to adjust the volume to 1 L. The resulting solution is placed in an alkali-resistant container to prevent contact with carbon dioxide etc., left standing for 3 days, and filtered to obtain a potassium hydroxide solution. The obtained potassium hydroxide solution is stored in an alkali-resistant container. The factor of the potassium hydroxide solution is determined by placing 25 mL of a 0.5 mol/L hydrochloric acid in an Erlenmeyer flask, adding thereto several drops of the aforementioned phenolphthalein solution, performing titration with the aforementioned potassium hydroxide solution, and determining the factor from the amount of the potassium hydroxide solution used for neutralization. The aforementioned 0.5 mol/L hydrochloric acid is prepared in accordance with JIS K 8001-1998.

### (2) Procedure

### (A) Main Test

Into a 200 mL round bottomed flask, 1.0 g of a sample is accurately weighed, and 5.0 mL of the aforementioned acetylated reagent is accurately added via a whole pipette. During this process, if the sample does not smoothly dissolve in the acetylated reagent, a small amount of guaranteed reagent toluene is added to effect dissolution.

A small funnel is placed on a port of the flask, and about 1 cm of the flask bottom is immersed in a glycerin bath at about 97° C. to conduct heating. Here, in order to prevent the temperature of the neck of the flask from elevating due to the heat from the bath, a cardboard with a round hole therein can be attached to the base of the neck.

After 1 hour, the flask is taken out of the glycerin bath and let cool. After cooling, 1 mL of water is added through the funnel, and the resulting mixture is shaken to hydrolyze the acetic anhydride. To complete hydrolysis, the flask is again heated over a glycerin bath for 10 minutes. After cooling, walls of the funnel and the flask are washed with 5 mL of ethyl alcohol.

Several drops of the phenolphthalein solution described above is added as an indicator, and titration is performed by using the aforementioned potassium hydroxide solution. The end point of the titration is when the pinkish color of the indicator continues for about 30 seconds.

### (B) Blank Test

Titration is performed as described above except that no sample is used.

(3) The obtained result is substituted into the following equation to calculate the hydroxyl value.

$$A = [ \{ ( B - C ) \times 28.05 \times f \} / S ] + D$$

Here, A: hydroxyl value (mgKOH/g), B: amount of potassium hydroxide solution added (mL) in blank test, C: amount of potassium hydroxide solution added (mL) in main test, f: factor of potassium hydroxide solution, S: sample (g), D: acid value of sample (mgKOH/g).

Features included in the embodiment of the present disclosure

The disclosure of the present embodiment includes the following features.

(Feature 1) A toner that contains toner particles containing a crystalline organic material,
in which the crystalline organic material contains a crystalline vinyl resin as an essential component, and further contains a crystalline polyester and a wax component as optional components,
a total content of the crystalline vinyl resin, the crystalline polyester, and the wax component with respect to the toner particles is 10.0 mass % or more and 90.0 mass % or less,
the crystalline vinyl resin contains a crystalline resin A that has:
   (i) units A represented by formula (1) above and
   (ii) units B represented by formula (2) above,
the toner particles contain 0.0020 mass % or more and 0.0500 mass % or less of a metal that can form a complex with an acetylacetonate moiety in a unit B of the crystalline resin A with respect to a mass of the toner particles,
the acetylacetonate moiety of at least one of the units B in the crystalline resin A forms a complex with the metal, and
in the crystalline resin A, a content of the unit B is 0.50 mass % or more and 10.0 mass % or less:
   (Feature 2) The toner described in feature 1, in which a total content of the crystalline organic material with respect to the toner particles is 30.0 mass % or more and 70.0 mass % or less.
   (Feature 3) The toner described in feature 1 or 2, in which a content of the unit A in the crystalline resin A is 40.0 mass % or more and 90.0 mass % or less.
   (Feature 4) The toner described in any one of features 1 to 3, in which the metal bonded to the unit B is one of Al, Zn, Fe, Cu, Co, Ni, Ti, Mg, and Mn.
   (Feature 5) The toner described in any one of features 1 to 3, in which the metal bonded to the unit B is aluminum.
   (Feature 6) The toner described in any one of features 1 to 5, in which content of the crystalline resin A in the crystalline organic material is 1.0 mass % or more and 70.0 mass % or less.
   (Feature 7) The toner described in any one of features 1 to 6, in which the crystalline resin A has an acid value (Av) and a hydroxyl value (OHv) of 5.0 mgKOH/g or less each.
   (Feature 8) The toner described in any one of features 1 to 7, in which the crystalline resin A has a melting point of 55.0° C. or higher and 70.0° C. or lower.
   (Feature 9) The toner described in any one of features 1 to 8, in which the crystalline vinyl resin in the crystalline organic material contains 80.0 mass % or more of a crystalline resin B that has a weight-average molecular weight (Mw) of 5000 or more and 50000 or less, that contains 40.0 mass % or more and 90.0 mass % or less of the units A represented by formula (1), and that contains less than 0.50 mass % of the units B.
   (Feature 10) The toner described in any one of features 1 to 9, in which the toner particles further contain an amorphous resin C,
the amorphous resin C is a styrene acrylic resin or a polyester resin,
the wax component in the crystalline organic material includes an ester wax, and
a content of the ester wax in the crystalline organic material is 70.0 mass % or more.
   (Feature 11) The toner described in any one of features 1 to 10, in which the metal bonded to the unit B is one of Al, Zn, Fe, Co, Ti, Mg, and Mn.

### EXAMPLES

The present disclosure will now be described specifically through examples that do not limit the present disclosure in any way.

### Production Example of Crystalline Resin A1

Into a reactor equipped with a reflux condenser, a stirrer, a thermometer, and a nitrogen inlet tube, the following materials were injected in a nitrogen atmosphere.
Toluene: 100.0 parts by mass
Behenyl acrylate: 80.0 parts by mass
Styrene: 18.5 parts by mass
Acetoacetoxyethyl methacrylate: 1.5 parts by mass
Polymerization initiator, t-butyl peroxypivalate (PERBUTYL PV produced by NOF CORPORATION): 2.0 parts by mass

While the content of the reactor was being stirred at 200 rpm, polymerization reaction was carried out for 12 hours under heating at 70° ° C. so as to obtain a solution containing a polymer of the monomer composition dissolved in toluene. Next, the solution was cooled to 25° C. and injected into 1000.0 parts by mass of methanol under stirring so as to deposit methanol-insoluble matter. The obtained methanol-insoluble matter was filtered out, washed with methanol, and vacuum dried at 40° C. for 24 hours to obtain a crystalline resin A1. The physical properties of the obtained crystalline resin A1 are shown in Table 2.

### Production Examples of Crystalline Resins A2 to A15

Crystalline resins A2 to A15 were obtained as in the production example of the crystalline resin A1 except that the monomers were changed as indicated in Table 1.

TABLE 1

| | Monomer 1 | | Monomer 2 | | Monomer 3 | | Monomer 4 | |
|---|---|---|---|---|---|---|---|---|
| | | Parts | | Parts | | Parts | | Parts |
| | | added | | added | | added | | added |
| | | (parts by | | (parts by | | (parts by | | (parts by |
| No. | Type | mass) | Type | mass) | Type | mass) | Type | mass) |
| A1 | BEA | 80.0 | AAEM | 1.50 | Styrene | 18.5 | — | — |
| A2 | BEA | 80.0 | AAEAA | 1.50 | Styrene | 18.5 | — | — |
| A3 | BEA | 80.0 | AAPM | 1.50 | Styrene | 18.5 | — | — |
| A4 | BEA | 80.0 | AAEM | 0.50 | Styrene | 19.5 | — | — |
| A5 | BEA | 80.0 | AAEM | 10.00 | Styrene | 10.0 | — | — |
| A6 | BEA | 40.0 | AAEM | 1.50 | Styrene | 58.5 | — | — |
| A7 | BEA | 37.0 | AAEM | 1.50 | Styrene | 61.5 | — | — |
| A8 | BEA | 90.0 | AAEM | 1.50 | Styrene | 8.5 | — | — |
| A9 | BEA | 95.0 | AAEM | 1.50 | Styrene | 3.5 | — | — |
| A10 | BEA | 80.0 | AAEM | 1.50 | Styrene | 17.8 | Acrylic | 0.71 |
| | | | | | | | acid | |
| A11 | BEA | 80.0 | AAEM | 1.50 | Styrene | 17.0 | Acrylic | 1.50 |
| | | | | | | | acid | |
| A12 | BEA | 80.0 | AAEM | 1.50 | Styrene | 17.9 | HEMA | 0.63 |
| A13 | BEA | 80.0 | AAEM | 1.50 | Styrene | 17.2 | HEMA | 1.31 |
| A14 | BEA | 35.0 | AAEM | 1.50 | Styrene | 63.5 | — | — |
| A15 | STA | 80.0 | AAEM | 1.50 | Styrene | 18.5 | — | — |

In Table 1. BEA represents behenyl acrylate. STA represents stearyl acrylate. AAEM represents acetoacetoxyethyl methacrylate. AAPM represents acetoacetoxypropyl methacrylate. AAEAA represents 2-[(1-oxo-2-propen-1-yl)amino]ethyl 3-oxobutanoate, and HEMA represents 2-hydroxyethyl methacrylate.

TABLE 2

| | | | | Weight- | | | | | | | | |
|---|---|---|---|---|---|---|---|---|---|---|---|---|
| | | | Melting | average | Structure of | | | | Structure of | | | |
| | | | point | molecular | unit A | | | Unit A | unit B | | | Unit B |
| Crystalline | Av | OHV | (Tm) | weight | (formula (1)) | | | content | (formula (2)) | | | content |
| resin No. | [mgKOH/g] | [mgKOH/g] | [° C.] | (Mw) | L₁ | m | R₁ | [mass %] | L₂ | R₂ | R₃ | [mass %] |
| A1 | 0.1 | 0.1 | 61.0 | 20000 | —COO— | 21 | H | 80.0 | —COO— | C₂H₄ | CH₃ | 1.50 |
| A2 | 0.1 | 0.1 | 61.0 | 20000 | —COO— | 21 | H | 80.0 | —CONH— | C₂H₄ | H | 1.50 |
| A3 | 0.1 | 0.1 | 61.0 | 20000 | —COO— | 21 | H | 80.0 | —COO— | C₃H₆ | CH₃ | 1.50 |
| A4 | 0.1 | 0.1 | 61.0 | 21000 | —COO— | 21 | H | 80.0 | —COO— | C₂H₄ | CH₃ | 0.50 |
| A5 | 0.1 | 0.1 | 61.0 | 23000 | —COO— | 21 | H | 80.0 | —COO— | C₂H₄ | CH₃ | 10.00 |
| A6 | 0.1 | 0.1 | 57.0 | 20000 | —COO— | 21 | H | 40.0 | —COO— | C₂H₄ | CH₃ | 1.50 |
| A7 | 0.1 | 0.1 | 57.0 | 20000 | —COO— | 21 | H | 37.0 | —COO— | C₂H₄ | CH₃ | 1.50 |
| A8 | 0.1 | 0.1 | 57.0 | 22000 | —COO— | 21 | H | 90.0 | —COO— | C₂H₄ | CH₃ | 1.50 |
| A9 | 0.1 | 0.1 | 57.0 | 20000 | —COO— | 21 | H | 95.0 | —COO— | C₂H₄ | CH₃ | 1.50 |
| A10 | 4.9 | 0.1 | 62.0 | 20000 | —COO— | 21 | H | 80.0 | —COO— | C₂H₄ | CH₃ | 1.50 |
| A11 | 10.0 | 0.1 | 63.0 | 20000 | —COO— | 21 | H | 80.0 | —COO— | C₂H₄ | CH₃ | 1.50 |
| A12 | 0.1 | 4.8 | 61.0 | 20000 | —COO— | 21 | H | 80.0 | —COO— | C₂H₄ | CH₃ | 1.50 |
| A13 | 0.1 | 10.0 | 61.0 | 20000 | —COO— | 21 | H | 80.0 | —COO— | C₂H₄ | CH₃ | 1.50 |
| A14 | 0.1 | 0.1 | 55.0 | 14000 | —COO— | 21 | H | 35.0 | —COO— | C₂H₄ | CH₃ | 1.50 |
| A15 | 0.1 | 0.1 | 46.0 | 20000 | —COO— | 17 | H | 80.0 | —COO— | C₂H₄ | CH₃ | 1.50 |

### Production Examples of Crystalline Resins B1 to B8

Crystalline resins B1 to B8 were obtained as in the production examples of the crystalline resins A except that the type of monomers, the amount added, and the amount of initiator were changed as indicated in Table 3. The physical properties of the obtained crystalline resins B1 to B8 are shown in Table 3.

TABLE 3

| | Monomer 1 | | Monomer 2 | | Monomer 3 | | Initiator | Physical properties | |
|---|---|---|---|---|---|---|---|---|---|
| | | Parts | | Parts | | Parts | Parts | Weight- | |
| | | added | | added | | added | added | average | Unit A |
| Crystalline | | (parts | | (parts | | (parts | (parts | molecular | content |
| resin B | Type | by mass) | Type | by mass) | Type | by mass) | by mass) | weight Mw | (mass %) |
| B1 | BEA | 80.0 | Styrene | 10.0 | MAN | 10.0 | 2.2 | 18000 | 80.0 |
| B2 | BEA | 80.0 | Styrene | 10.0 | MAN | 10.0 | 6.0 | 5000 | 77.0 |
| B3 | BEA | 80.0 | Styrene | 10.0 | MAN | 10.0 | 6.5 | 4500 | 76.0 |
| B4 | BEA | 80.0 | Styrene | 10.0 | MAN | 10.0 | 1.0 | 49000 | 80.0 |
| B5 | BEA | 80.0 | Styrene | 10.0 | MAN | 10.0 | 0.5 | 80000 | 80.0 |
| B6 | BEA | 40.0 | Styrene | 30.0 | MAN | 30.0 | 2.2 | 18000 | 40.0 |
| B7 | BEA | 35.0 | Styrene | 35.0 | MAN | 30.0 | 2.2 | 18000 | 35.0 |
| B8 | BEA | 90.0 | Styrene | 10.0 | — | — | 2.4 | 18000 | 90.0 |

In Table 3, BEA represents behenyl acrylate and MAN represents methacrylonitrile.

### Production of Crystalline Polyester 1

Into a reactor equipped with a stirrer, a thermometer, a nitrogen inlet tube, a dewatering tube, and a decompressor, 100.0 parts by mass of 1,10-decanedicarboxylic acid and 120.0 parts by mass of 1,12-dodecanediol were added, and the resulting mixture was heated to 130° ° C. under stirring. After 0.7 parts by mass of titanium(IV) isopropoxide was added as an esterification catalyst, the temperature was elevated to 160° C., and condensation polymerization was carried out over a period of 5 hours. Then the temperature was elevated to 180ºC, and the reaction was induced until a desired molecular weight was reached while reducing the pressure so as to obtain a crystalline polyester 1.

### Production Example of Amorphous Resin C1

Into an auto reactor equipped with a decompressor, a water separator, a nitrogen gas inlet device, a temperature measuring device, and a stirrer, the following materials were added.
Terephthalic acid: 29.9 parts by mass
Bisphenol A-propylene oxide 2 mol adduct: 40.0 parts by mass
Isosorbide: 10.0 parts by mass
Ethylene glycol: 4.5 parts by mass
Tetrabutoxy titanate: 0.125 parts by mass
   The aforementioned monomers and catalyst were charged, and condensation polymerization was carried out in a nitrogen atmosphere at a normal pressure at 200° ° C. for 5 hours to obtain an amorphous resin C1.

### Production Example of Amorphous Resin C2

Styrene: 80.0 parts by mass
Butyl acrylate (n-BA): 18.0 parts by mass
Acrylic acid: 2.0 parts by mass
Toluene: 50.0 parts by mass

The aforementioned materials were mixed and heated to 70° C., and while the mixture was being stirred, 1.0 part by mass of t-butyl peroxypivalate was added as the polymerization initiator. Then polymerization was carried out for 5 hours while keeping 70° C., and the temperature was further elevated to 85° C. and kept thereat for 2 hours. After cooling, re-deposition in methanol, filtration, and drying were performed to obtain an amorphous resin C2.

### Production Example of Toner Particles 1

### Production of Toner by Suspension Polymerization Method

Butyl acrylate (n-BA): 10.4 parts by mass
Styrene: 31.3 parts by mass
Colorant Pigment Blue 15:3: 5.0 parts by mass

A mixture containing the aforementioned materials was prepared. The mixture was injected into an attritor (produced by NIPPON COKE & ENGINEERING CO., LTD.) and dispersed at 200 rpm for 2 hours with zirconia beads having a diameter of 5 mm to obtain a raw material dispersion.

Meanwhile, 735.0 parts by mass of deionized water and 16.0 parts by mass of trisodium phosphate (12 hydrate) were added to a container equipped with a high-speed stirrer homomixer (produced by PRIMIX corporation) and a thermometer, and the resulting mixture was heated to 60° C. while being stirred at 12000 rpm. Thereto, an aqueous calcium chloride solution prepared by dissolving 9.0 parts by mass of calcium chloride (2 hydrate) in 65.0 parts by mass of deionized water was charged, and the resulting mixture was stirred at 12000 rpm for 30 minutes while keeping 60° ° C. Thereto, 10% hydrochloric acid was added to adjust the pH to 6.0 so as to obtain an aqueous medium in which an inorganic dispersion stabilizer containing hydroxyapatite was dispersed in water.

Next, this raw material dispersion was transferred to a container equipped with a stirrer and a thermometer, and was heated to 60° C. while being stirred at 100 rpm.
Crystalline resin A1: 5.0 parts by mass
Crystalline resin B1: 40.0 parts by mass
Aluminum distearate: 0.30 parts by mass
Hydrocarbon WAX: 5.0 parts by mass
   (Hydrocarbon WAX: paraffin wax HNP-9 produced by NIPPON SEIRO CO., LTD.)
Amorphous resin C2: 3.0 parts by mass

Thereto, the aforementioned materials were added, and the resulting mixture was stirred at 100 rpm for 30 minutes while keeping 60° C. Thereto, 9.0 parts by mass of t-butyl peroxypivalate (PERBUTYL PV produced by NOF CORPORATION) was added as a polymerization initiator, followed by stirring for 1 minute, and then the resulting solution was injected into the aqueous medium being stirred at 12000 rpm by the high-speed stirrer. Stirring was continued at 12000 rpm for 20 minutes by the high-speed stirrer while keeping 60° ° C. so as to obtain a particle-forming solution.

The particle-forming solution was transferred into a reactor equipped with a reflux condenser, a stirrer, a thermometer, and a nitrogen inlet tube, and was heated to 70° C. in a nitrogen atmosphere while being stirred at 150 rpm. The polymerization reaction was carried out for 12 hours at 150 rpm while keeping 70° ° C. so as to obtain a toner-particle dispersion liquid.

The obtained toner-particle dispersion liquid was cooled to 45° C. while being stirred at 150 rpm and then heated for 5 hours while keeping 45° C. Subsequently, diluted hydrochloric acid was added until pH reached 1.5 under stirring to dissolve the dispersion stabilizer. The solid matter was filtered out, thoroughly washed with deionized water, and vacuum-dried at 30° ° C. for 24 hours to obtain toner particles 1. The weight average particle diameter of the obtained toner particles 1 was 6.9 μm. The properties of the obtained toner particles 1 are shown in Table 5.

### Production Examples of Toner Particles 2 to 46 and Comparative Toner Particles 1 to 3

Toner particles 2 to 46 and comparative toner particles 1 to 3 were obtained as in the production example of the toner particles 1 described above except that the types and amounts of the materials added were changed as shown in Table 4. The properties of the obtained toner particles 2 to 46 and comparative toner particles 1 to 3 are shown in Table 5.

TABLE 4

| | | | | | | | | | | | Monomers | | | |
|---|---|---|---|---|---|---|---|---|---|---|---|---|---|---|
| | Crystalline organic material | | | | | | | | | | for forming | | Metal- | |
| | Crystalline | | Crystalline | | | | | | Crystalline | | amorphous resin C | | containing | |
| Toner | resin A | | resin B | | Wax 1 | | Wax 2 | | polyester | | Amount of | Amount | material | |
| particle | | Amount | | Amount | | Amount | | Amount | | Amount | styrene | of n-BA | | Amount |
| No. | Type | (parts) | Type | (parts) | Type | (parts) | Type | (parts) | Type | (parts) | (parts) | (parts) | Type | (parts) |
| 1 | A1 | 5.0 | B1 | 40.0 | HNP9 | 5.0 | — | 0.0 | — | 0.0 | 31.3 | 10.4 | di-STAl | 0.30 |
| 2 | A2 | 5.0 | B1 | 40.0 | HNP9 | 5.0 | — | 0.0 | — | 0.0 | 31.3 | 10.4 | di-STAl | 0.30 |
| 3 | A3 | 5.0 | B1 | 40.0 | HNP9 | 5.0 | — | 0.0 | — | 0.0 | 31.3 | 10.4 | di-STAl | 0.30 |
| 4 | A4 | 5.0 | B1 | 40.0 | HNP9 | 5.0 | — | 0.0 | — | 0.0 | 31.3 | 10.4 | di-STAl | 0.30 |
| 5 | A5 | 5.0 | B1 | 40.0 | HNP9 | 5.0 | — | 0.0 | — | 0.0 | 31.3 | 10.4 | di-STAl | 0.30 |
| 6 | A1 | 1.0 | — | 0.0 | HNP9 | 5.0 | Behenyl | 6.0 | — | 0.0 | 61.3 | 20.4 | di-STAl | 0.30 |
| | | | | | | | behenate | | | | | | | |
| 7 | A1 | 8.0 | B1 | 77.0 | HNP9 | 5.0 | — | 0.0 | — | 0.0 | 2.8 | 0.9 | di-STAl | 0.30 |
| 8 | A1 | 5.0 | B1 | 40.0 | HNP9 | 5.0 | — | 0.0 | — | 0.0 | 31.5 | 10.5 | di-STAl | 0.05 |
| 9 | A2 | 5.0 | B1 | 40.0 | HNP9 | 5.0 | — | 0.0 | — | 0.0 | 30.7 | 10.2 | di-STAl | 1.10 |
| 10 | A1 | 5.0 | B1 | 20.0 | HNP9 | 5.0 | — | 0.0 | — | 0.0 | 46.3 | 15.4 | di-STAl | 0.30 |
| 11 | A1 | 5.0 | B1 | 17.0 | HNP9 | 5.0 | — | 0.0 | — | 0.0 | 48.5 | 16.2 | di-STAl | 0.30 |
| 12 | A1 | 5.0 | B1 | 60.0 | HNP9 | 5.0 | — | 0.0 | — | 0.0 | 16.3 | 5.4 | di-STAl | 0.30 |
| 13 | A1 | 5.0 | B1 | 70.0 | HNP9 | 5.0 | — | 0.0 | — | 0.0 | 8.8 | 2.9 | di-STAl | 0.30 |
| 14 | A6 | 5.0 | B1 | 40.0 | HNP9 | 5.0 | — | 0.0 | — | 0.0 | 31.3 | 10.4 | di-STAl | 0.30 |
| 15 | A7 | 5.0 | B1 | 40.0 | HNP9 | 5.0 | — | 0.0 | — | 0.0 | 31.3 | 10.4 | di-STAl | 0.30 |
| 16 | A8 | 5.0 | B1 | 40.0 | HNP9 | 5.0 | — | 0.0 | — | 0.0 | 31.3 | 10.4 | di-STAl | 0.30 |
| 17 | A9 | 5.0 | B1 | 40.0 | HNP9 | 5.0 | — | 0.0 | — | 0.0 | 31.3 | 10.4 | di-STAl | 0.30 |
| 18 | A1 | 5.0 | B1 | 40.0 | HNP9 | 5.0 | — | 0.0 | — | 0.0 | 31.3 | 10.4 | di-STCo | 0.30 |
| 19 | A1 | 5.0 | B1 | 40.0 | HNP9 | 5.0 | — | 0.0 | — | 0.0 | 31.3 | 10.4 | di-STMg | 0.30 |
| 20 | A1 | 5.0 | B1 | 40.0 | HNP9 | 5.0 | — | 0.0 | — | 0.0 | 31.3 | 10.4 | di-STCu | 0.30 |
| 21 | A1 | 5.0 | B1 | 40.0 | HNP9 | 5.0 | — | 0.0 | — | 0.0 | 31.3 | 10.4 | di-STZn | 0.30 |
| 22 | A1 | 5.0 | B1 | 40.0 | HNP9 | 5.0 | — | 0.0 | — | 0.0 | 31.3 | 10.4 | tri-STFe | 0.30 |
| 23 | A1 | 5.0 | B1 | 40.0 | HNP9 | 5.0 | — | 0.0 | — | 0.0 | 31.3 | 10.4 | di-STNi | 0.30 |
| 24 | A1 | 5.0 | B1 | 40.0 | HNP9 | 5.0 | — | 0.0 | — | 0.0 | 31.3 | 10.4 | Ti-ipr | 0.30 |
| 25 | A1 | 5.0 | B1 | 40.0 | HNP9 | 5.0 | — | 0.0 | — | 0.0 | 31.3 | 10.4 | di-STMn | 0.30 |
| 26 | A1 | 5.0 | B1 | 40.0 | HNP9 | 5.0 | — | 0.0 | — | 0.0 | 31.3 | 10.4 | di-STCa | 0.30 |
| 27 | A1 | 0.5 | B1 | 40.0 | HNP9 | 5.0 | — | 0.0 | — | 0.0 | 34.7 | 11.6 | di-STAl | 0.30 |
| 28 | A1 | 0.3 | B1 | 40.0 | HNP9 | 5.0 | — | 0.0 | — | 0.0 | 34.8 | 11.6 | di-STAl | 0.30 |
| 29 | A1 | 34.0 | B1 | 10.0 | HNP9 | 5.0 | — | 0.0 | — | 0.0 | 32.0 | 10.7 | di-STAl | 0.30 |
| 30 | A1 | 30.0 | B1 | 5.0 | HNP9 | 5.0 | — | 0.0 | — | 0.0 | 38.8 | 12.9 | di-STAl | 0.30 |
| 31 | A10 | 5.0 | B1 | 40.0 | HNP9 | 5.0 | — | 0.0 | — | 0.0 | 31.3 | 10.4 | di-STAl | 0.30 |
| 32 | A11 | 5.0 | B1 | 40.0 | HNP9 | 5.0 | — | 0.0 | — | 0.0 | 31.3 | 10.4 | di-STAl | 0.30 |
| 33 | A12 | 5.0 | B1 | 40.0 | HNP9 | 5.0 | — | 0.0 | — | 0.0 | 31.3 | 10.4 | di-STAl | 0.30 |
| 34 | A13 | 5.0 | B1 | 40.0 | HNP9 | 5.0 | — | 0.0 | — | 0.0 | 31.3 | 10.4 | di-STAl | 0.30 |
| 35 | A14 | 5.0 | B1 | 40.0 | HNP9 | 5.0 | — | 0.0 | — | 0.0 | 31.3 | 10.4 | di-STAl | 0.30 |
| 36 | A15 | 5.0 | B1 | 40.0 | HNP9 | 5.0 | — | 0.0 | — | 0.0 | 31.3 | 10.4 | di-STAl | 0.30 |
| 37 | A1 | 5.0 | B2 | 40.0 | HNP9 | 5.0 | — | 0.0 | — | 0.0 | 31.3 | 10.4 | di-STAl | 0.30 |
| 38 | A1 | 5.0 | B3 | 40.0 | HNP9 | 5.0 | — | 0.0 | — | 0.0 | 31.3 | 10.4 | di-STAl | 0.30 |
| 39 | A1 | 5.0 | B4 | 40.0 | HNP9 | 5.0 | — | 0.0 | — | 0.0 | 31.3 | 10.4 | di-STAl | 0.30 |
| 40 | A1 | 5.0 | B5 | 40.0 | HNP9 | 5.0 | — | 0.0 | — | 0.0 | 31.3 | 10.4 | di-STAl | 0.30 |
| 41 | A1 | 5.0 | B6 | 40.0 | HNP9 | 5.0 | — | 0.0 | — | 0.0 | 31.3 | 10.4 | di-STAl | 0.30 |
| 42 | A1 | 5.0 | B7 | 40.0 | HNP9 | 5.0 | — | 0.0 | — | 0.0 | 31.3 | 10.4 | di-STAl | 0.30 |
| 43 | A1 | 5.0 | B1 | 20.0 | HNP9 | 5.0 | — | 0.0 | 1 | 20.0 | 31.3 | 10.4 | di-STAl | 0.30 |
| 44 | A1 | 5.0 | — | 0.0 | HNP9 | 5.0 | — | 0.0 | 1 | 30.0 | 38.8 | 12.9 | di-STAl | 0.30 |
| 45 | A1 | 5.0 | — | 0.0 | HNP9 | 5.0 | Behenyl | 25.0 | — | 0.0 | 42.5 | 14.2 | di-STAl | 0.30 |
| | | | | | | | behenate | | | | | | | |
| 46 | A1 | 5.0 | — | 0.0 | HNP9 | 5.0 | EG18 | 25.0 | — | 0.0 | 42.5 | 14.2 | di-STAl | 0.30 |
| Comparative 1 | — | 0.0 | B8 | 40.0 | HNP9 | 5.0 | — | 0.0 | — | 0.0 | 35.0 | 11.7 | di-STAl | 0.30 |
| Comparative 2 | A15 | 2.0 | — | 0.0 | HNP9 | 5.0 | — | 0.0 | — | 0.0 | 63.5 | 21.2 | di-STAl | 0.30 |
| Comparative 3 | A15 | 2.0 | B1 | 40.0 | HNP9 | 5.0 | — | 0.0 | — | 0.0 | 33.8 | 11.3 | — | 0.00 |

In Table 4, “parts” indicates parts by mass, EG18 represents ethylene glycol distearate, di-STAI represents aluminum distearate, di-STCo represents cobalt distearate, di-STMg represents magnesium distearate, di-STCu represents copper distearate, di-STZn represents zinc distearate, di-STCa represents calcium distearate, tri-STFe represents iron tristearate, di-STNi represents nickel distearate, Ti-ipr represents titanium tetraisopropoxide, and di-STMn represents manganese distearate.

### Production Example of Toner Particles 47

### Production of Toner by Pulverization Method

Crystalline resin A: 5.0 parts by mass
Amorphous resin C1: 59.7 parts by mass
Ethylene glycol distearate: 25.0 parts by mass
Hydrocarbon WAX: 5.0 parts by mass
   (Hydrocarbon WAX: paraffin wax HNP-9 produced by NIPPON SEIRO CO., LTD.)
Colorant Pigment Blue 15:3: 5.0 parts by mass
Aluminum distearate: 0.30 parts by mass

The raw materials indicated in the aforementioned prescription were mixed in a Henschel Mixer (model FM-75 produced by Mitsui Mining Co., Ltd.) at a rotation rate of 20 s⁻¹ for a rotation time of 5 min, and then kneaded with a twin screw kneader (model PCM-30 produced by Ikegai Corporation) with the temperature set to 125° C. The obtained kneaded product was cooled and roughly pulverized to 1 mm or smaller with a hammer mill to obtain a roughly pulverized matter. The roughly pulverized matter was finely pulverized with a mechanical pulverizer (T-250 produced by TURBO CORPORATION). The finely pulverized matter was classified by using a rotary classifier (200TSP produced by HOSOKAWA MICRON CORPORATION) to obtain toner particles 47. The weight average particle diameter of the obtained toner particles 47 was 7.5 μm. The properties thereof are shown in Table 5.

### Production Example of Toner Particles 48

In the production example of the toner particles 47, the raw materials were changed as follows.
Crystalline resin A: 5.0 parts by mass
Amorphous resin C1: 64.7 parts by mass
Crystalline polyester 1: 20.0 parts by mass
Hydrocarbon WAX: 5.0 parts by mass
   (Hydrocarbon WAX: paraffin wax HNP-9 produced by NIPPON SEIRO CO., LTD.)
Colorant Pigment Blue 15:3: 5.0 parts by mass
Aluminum distearate: 0.30 parts by mass

Toner particles 48 were obtained as in the production example of the toner particles 47. The weight average particle diameter of the obtained toner particles 48 was 7.8 μm. The properties thereof are shown in Table 5.

TABLE 5

| | Crystalline | Crystalline | Crystalline | Ester wax | | | | Weight- |
|---|---|---|---|---|---|---|---|---|
| | organic | resin A content | resin B content | content in | | | Metal that has | average |
| | material | in crystalline | in crystalline | crystalline | Metal that can form a | | formed a | particle |
| | content in | organic | organic | organic | complex with unit B | | complex | size of |
| | toner particles | material | material | material | | Amount | Detected/ | toner |
| Toner particles | [mass %] | [mass %] | [mass %] | [mass %] | Type | [mass %] | undetected | [μm] |
| Toner particles 1 | 50.0 | 10.0 | 80.0 | 0.0 | Al | 0.0132 | Detected | 6.9 |
| Toner particles 2 | 50.0 | 10.0 | 80.0 | 0.0 | Al | 0.0132 | Detected | 7.1 |
| Toner particles 3 | 50.0 | 10.0 | 80.0 | 0.0 | Al | 0.0132 | Detected | 6.8 |
| Toner particles 4 | 50.0 | 10.0 | 80.0 | 0.0 | Al | 0.0132 | Detected | 7.7 |
| Toner particles 5 | 50.0 | 10.0 | 80.0 | 0.0 | Al | 0.0132 | Detected | 6.7 |
| Toner particles 6 | 10.0 | 10.0 | 0.0 | 60.0 | Al | 0.0132 | Detected | 7.3 |
| Toner particles 7 | 88.0 | 9.1 | 87.5 | 0.0 | Al | 0.0132 | Detected | 6.1 |
| Toner particles 8 | 50.0 | 10.0 | 80.0 | 0.0 | Al | 0.0022 | Detected | 6.2 |
| Toner particles 9 | 50.0 | 10.0 | 80.0 | 0.0 | Al | 0.0486 | Detected | 7.1 |
| Toner particles 10 | 30.0 | 16.7 | 66.7 | 0.0 | Al | 0.0132 | Detected | 6.6 |
| Toner particles 11 | 27.0 | 18.5 | 63.0 | 0.0 | Al | 0.0132 | Detected | 7.5 |
| Toner particles 12 | 70.0 | 7.1 | 85.7 | 0.0 | Al | 0.0132 | Detected | 6.3 |
| Toner particles 13 | 80.0 | 6.3 | 87.5 | 0.0 | Al | 0.0132 | Detected | 7.6 |
| Toner particles 14 | 50.0 | 10.0 | 80.0 | 0.0 | Al | 0.0132 | Detected | 6.5 |
| Toner particles 15 | 50.0 | 10.0 | 80.0 | 0.0 | Al | 0.0132 | Detected | 7.5 |
| Toner particles 16 | 50.0 | 10.0 | 80.0 | 0.0 | Al | 0.0132 | Detected | 7.7 |
| Toner particles 17 | 50.0 | 10.0 | 80.0 | 0.0 | Al | 0.0132 | Detected | 6.5 |
| Toner particles 18 | 50.0 | 10.0 | 80.0 | 0.0 | Co | 0.0129 | Detected | 6.1 |
| Toner particles 19 | 50.0 | 10.0 | 80.0 | 0.0 | Mg | 0.0137 | Detected | 7.1 |
| Toner particles 20 | 50.0 | 10.0 | 80.0 | 0.0 | Cu | 0.0137 | Detected | 7.5 |
| Toner particles 21 | 50.0 | 10.0 | 80.0 | 0.0 | Zn | 0.0128 | Detected | 7.0 |
| Toner particles 22 | 50.0 | 10.0 | 80.0 | 0.0 | Fe | 0.0089 | Detected | 7.0 |
| Toner particles 23 | 50.0 | 10.0 | 80.0 | 0.0 | Ni | 0.0129 | Detected | 7.0 |
| Toner particles 24 | 50.0 | 10.0 | 80.0 | 0.0 | Ti | 0.0285 | Detected | 7.0 |
| Toner particles 25 | 50.0 | 10.0 | 80.0 | 0.0 | Mn | 0.0127 | Detected | 7.0 |
| Toner particles 26 | 50.0 | 10.0 | 80.0 | 0.0 | Ca | 0.0133 | Detected | 7.2 |
| Toner particles 27 | 45.5 | 1.1 | 87.9 | 0.0 | Al | 0.0132 | Detected | 7.3 |
| Toner particles 28 | 45.3 | 0.7 | 88.1 | 0.0 | Al | 0.0132 | Detected | 7.0 |
| Toner particles 29 | 49.0 | 69.4 | 0.0 | 0.0 | Al | 0.0132 | Detected | 6.4 |
| Toner particles 30 | 40.0 | 75.0 | 0.0 | 0.0 | Al | 0.0132 | Detected | 6.7 |
| Toner particles 31 | 50.0 | 10.0 | 80.0 | 0.0 | Al | 0.0132 | Detected | 7.0 |
| Toner particles 32 | 50.0 | 10.0 | 80.0 | 0.0 | Al | 0.0132 | Detected | 7.0 |
| Toner particles 33 | 50.0 | 10.0 | 80.0 | 0.0 | Al | 0.0132 | Detected | 7.1 |
| Toner particles 34 | 50.0 | 10.0 | 80.0 | 0.0 | Al | 0.0132 | Detected | 7.2 |
| Toner particles 35 | 50.0 | 10.0 | 80.0 | 0.0 | Al | 0.0132 | Detected | 6.8 |
| Toner particles 36 | 50.0 | 10.0 | 80.0 | 0.0 | Al | 0.0132 | Detected | 6.7 |
| Toner particles 37 | 50.0 | 10.0 | 80.0 | 0.0 | Al | 0.0132 | Detected | 6.8 |
| Toner particles 38 | 50.0 | 10.0 | 80.0 | 0.0 | Al | 0.0132 | Detected | 6.9 |
| Toner particles 39 | 50.0 | 10.0 | 80.0 | 0.0 | Al | 0.0132 | Detected | 6.8 |
| Toner particles 40 | 50.0 | 10.0 | 80.0 | 0.0 | Al | 0.0132 | Detected | 6.9 |
| Toner particles 41 | 50.0 | 10.0 | 80.0 | 0.0 | Al | 0.0132 | Detected | 6.9 |
| Toner particles 42 | 50.0 | 10.0 | 80.0 | 0.0 | Al | 0.0132 | Detected | 6.9 |
| Toner particles 43 | 50.0 | 10.0 | 40.0 | 0.0 | Al | 0.0132 | Detected | 6.8 |
| Toner particles 44 | 40.0 | 12.5 | 0.0 | 0.0 | Al | 0.0132 | Detected | 6.8 |
| Toner particles 45 | 35.0 | 14.3 | 0.0 | 71.4 | Al | 0.0132 | Detected | 7.0 |
| Toner particles 46 | 35.0 | 14.3 | 0.0 | 71.4 | Al | 0.0132 | Detected | 7.1 |
| Toner particles 47 | 35.0 | 14.3 | 0.0 | 71.4 | Al | 0.0132 | Detected | 7.5 |
| Toner particles 48 | 30.0 | 16.7 | 0.0 | 0.0 | Al | 0.0132 | Detected | 7.8 |
| Comparative toner 1 | 45.0 | 0.0 | 88.9 | 0.0 | Al | 0.0132 | Undetected | 6.8 |
| Comparative toner 2 | 7.0 | 28.6 | 0.0 | 0.0 | Al | 0.0132 | Detected | 7.5 |
| Comparative toner 3 | 47.0 | 4.3 | 85.1 | 0.0 | — | 0.0000 | — | 6.8 |

### Production Example of Toner 1

To 98.0 parts by mass of the aforementioned toner particles 1, 2.0 parts by mass of silica fine particles (hydrophobized with hexamethyldisilazane, number average particle size of primary particles: 10 nm, BET specific surface area: 170 m²/g) were added as an external additive, and the resulting mixture was mixed at 3000 rpm for 15 minutes to obtain a toner 1.

### Production Examples of Toners 2 to 48 and Comparative Toners 1 to 3

Toners 2 to 48 and comparative toners 1 to 3 were obtained as in the production example of the toner 1 described above except that the toner particles 2 to 48 and the comparative toner particles 1 to 3 were used.

### Examples 1 to 48

The toners 1 to 48 were evaluated by the following methods.

### Comparative Examples 1 to 3

Comparative toners 1 to 3 were evaluated by the following methods.

The evaluation methods for the toners were as follows.

### Method for Evaluating Low-Temperature Fixability

A process cartridge loaded with a toner used for evaluation was left to stand for 48 hours at 25° C. and a humidity of 40% RH. LBP-712Ci (produced by CANON KABUSHIKI KAISHA) modified so that it could operate without a fixing unit was used to output an unfixed image of an image pattern in which 10 mm×10 mm square images were arranged evenly at 9 points throughout a sheet of recording paper. The toner bearing amount on the recording paper was set to 0.80 mg/cm², and the fixing start temperature was evaluated. As the recording paper, normal A4 paper (“Plover Bond” paper: 105 g/m² produced by Fox River Paper Company) was used. The fixing unit was taken out of LBP-712Ci, and an external fixing unit that could operate outside the laser beam printer was used.

The fixing temperature of the external fixing unit was elevated from 100° C. in 5ºC increments, and fixing on the normal paper was performed under the condition of a process speed: 330 mm/sec. The fixed image was rubbed ten times with a Kim Wipe (S-200 produced by NIPPON PAPER CRECIA CO., LTD.) by applying a load of 7.35 kPa (75 g/cm²), and the temperature at which the density-decreasing rate before and after rubbing was less than 5% was assumed to be the fixing start temperature. The fixing start temperature was evaluated by the following standard, and a rating of C or higher was considered satisfactory. The evaluation results are shown in Table 6.

### Evaluation Standard

A: The fixing start temperature is 110° C. or lower.
B: The fixing start temperature is 115° C. or higher and 120° C. or lower.
C: The fixing start temperature is 125° C. or higher and 130° C. or lower.
D: The fixing start temperature is 135° C. or higher.

### Method for Evaluating Heat-Resistant Storage Stability

Into a 50 cc polyethylene cup, 5 g of a toner was placed and left standing for 72 hours at a temperature of 50° C. and a humidity of 10% RH, and at a temperature of 55° C. and a humidity of 10% RH. Whether there were cohesion clusters in the toner left standing was evaluated. In the present disclosure, a C rank or higher exhibits satisfactory heat-resistant storage stability. The results are shown in Table 6.

### Evaluation Standard

A: No cohesion clusters were generated.
B: Minute cohesion clusters were generated but disintegrated when pushed with a finger.
C: Cohesion clusters were generated and did not disintegrate when pushed with a finger.
D: The toner was completely cohered.

### Evaluation of Charging Stability in HH and LL Environments

As the image forming apparatus, a modified model of a commercially available laser printer, LBP-712Ci (produced by CANON KABUSHIKI KAISHA), was used. The modification involved establishing a connection with an external high-voltage power source so that the potential of charging and transfer, etc., can be reversed and that images can be formed with a negatively chargeable toner and a positively chargeable toner. The process speed was set to 210 mm/sec.

A commercially available toner cartridge 040H (cyan) (produced by CANON KABUSHIKI KAISHA) was used as the process cartridge. The product toner was taken out of the cartridge, the cartridge was cleaned by air blowing, and then 165 g of the toner used for evaluation was loaded.

Product toners were taken out of the yellow, magenta, and black stations, and then yellow, magenta, and black cartridges with nullified remaining toner quantity detection mechanisms were inserted to conduct evaluation.

An image having a printing ratio of 1% was continuously output in a low-temperature, low-humidity (LL) environment having a temperature of 15° C. and a humidity of 10% RH and in a high-temperature, high-humidity (HH) environment having a temperature of 30° C. and a humidity of 85% RH. Ultimately, the image was output on 10,000 sheets, and the fogging density in a solid white portion was evaluated by the following method.

A solid white image was output, and the fogging value was determined as [Dr−Ds (%)] where Ds represents the white portion reflection density worst value and Dr (%) represents the reflection average density of the transfer material before the image formation. The white portion reflection density was measured with a reflection density meter (REFLECTOMETER model TC-6DS produced by Tokyo Denshoku Co., Ltd.), and an amberlite filter was used as the filter. The smaller the numerical value, the higher the evaluation rating. The evaluation standard is as follows. The evaluation results are shown in Table 6.

### Evaluation Standard

A: Less than 0.5%.
B: 0.5% or more and less than 1.5%
C: 1.5% or more and less than 3.0%
D: 3.0% or more

TABLE 6

| | | Low-temperature | | | | LL charge | | HH charge | |
|---|---|---|---|---|---|---|---|---|---|
| | | fixability | | Heat-resistant | | stability | | stability | |
| | | Fixing start | | storage stability | | Fogging | | Fogging | |
| | | temperature | | 50° C./ | 55° C./ | density | | density | |
| Example | Toner | [° C.] | Rank | 72 hr | 72 hr | [%] | Rank | [%] | Rank |
| Example 1 | Toner 1 | 105 | A | A | A | 0.3 | A | 0.2 | A |
| Example 2 | Toner 2 | 105 | A | A | B | 0.3 | A | 0.2 | A |
| Example 3 | Toner 3 | 105 | A | A | A | 0.3 | A | 0.2 | A |
| Example 4 | Toner 4 | 105 | A | B | C | 2.7 | C | 0.2 | A |
| Example 5 | Toner 5 | 105 | A | A | A | 0.3 | A | 1.1 | B |
| Example 6 | Toner 6 | 130 | C | A | A | 0.3 | A | 0.3 | A |
| Example 7 | Toner 7 | 100 | A | A | B | 0.9 | B | 2.8 | C |
| Example 8 | Toner 8 | 105 | A | B | C | 0.3 | A | 0.3 | A |
| Example 9 | Toner 9 | 105 | A | A | A | 0.3 | A | 2.7 | C |
| Example 10 | Toner 10 | 120 | B | A | A | 0.3 | A | 0.3 | A |
| Example 11 | Toner 11 | 130 | C | A | A | 0.3 | A | 0.3 | A |
| Example 12 | Toner 12 | 105 | A | A | A | 1.4 | B | 0.9 | B |
| Example 13 | Toner 13 | 105 | A | A | B | 2.8 | C | 2.5 | C |
| Example 14 | Toner 14 | 105 | A | A | B | 0.3 | A | 0.3 | A |
| Example 15 | Toner 15 | 105 | A | B | C | 0.4 | A | 0.3 | A |
| Example 16 | Toner 16 | 105 | A | A | B | 0.3 | A | 0.3 | A |
| Example 17 | Toner 17 | 105 | A | B | B | 0.3 | A | 0.3 | A |
| Example 18 | Toner 18 | 105 | A | A | B | 0.3 | A | 0.3 | A |
| Example 19 | Toner 19 | 105 | A | A | B | 0.3 | A | 0.3 | A |
| Example 20 | Toner 20 | 105 | A | B | C | 0.3 | A | 0.3 | A |
| Example 21 | Toner 21 | 105 | A | A | B | 0.3 | A | 0.3 | A |
| Example 22 | Toner 22 | 105 | A | A | B | 0.4 | A | 0.3 | A |
| Example 23 | Toner 23 | 105 | A | B | C | 0.3 | A | 0.3 | A |
| Example 24 | Toner 24 | 105 | A | A | B | 0.4 | A | 0.4 | A |
| Example 25 | Toner 25 | 105 | A | A | B | 0.4 | A | 0.3 | A |
| Example 26 | Toner 26 | 105 | A | A | C | 0.3 | A | 0.9 | B |
| Example 27 | Toner 27 | 110 | A | B | B | 1.2 | B | 0.8 | B |
| Example 28 | Toner 28 | 110 | A | B | C | 2.9 | C | 0.7 | B |
| Example 29 | Toner 29 | 110 | A | A | A | 0.3 | A | 0.9 | B |
| Example 30 | Toner 30 | 110 | A | A | A | 0.1 | A | 1.6 | C |
| Example 31 | Toner 31 | 105 | A | A | A | 0.3 | A | 0.7 | B |
| Example 32 | Toner 32 | 105 | A | A | A | 0.3 | A | 2.5 | C |
| Example 33 | Toner 33 | 105 | A | A | A | 0.2 | A | 0.8 | B |
| Example 34 | Toner 34 | 105 | A | A | A | 0.4 | A | 2.8 | C |
| Example 35 | Toner 35 | 105 | A | A | B | 0.3 | A | 0.3 | A |
| Example 36 | Toner 36 | 105 | A | A | C | 0.3 | A | 0.3 | A |
| Example 37 | Toner 37 | 105 | A | A | B | 0.3 | A | 0.3 | A |
| Example 38 | Toner 38 | 105 | A | B | B | 0.3 | A | 0.3 | A |
| Example 39 | Toner 39 | 110 | A | A | A | 0.3 | A | 0.3 | A |
| Example 40 | Toner 40 | 105 | A | A | A | 0.3 | A | 0.3 | A |
| Example 41 | Toner 41 | 105 | A | A | B | 0.3 | A | 0.3 | A |
| Example 42 | Toner 42 | 105 | C | B | C | 0.3 | A | 0.3 | A |
| Example 43 | Toner 43 | 105 | A | A | B | 0.3 | A | 0.9 | B |
| Example 44 | Toner 44 | 105 | A | B | C | 0.3 | A | 2.5 | C |
| Example 45 | Toner 45 | 120 | B | B | B | 0.3 | A | 0.2 | A |
| Example 46 | Toner 46 | 110 | A | B | B | 0.3 | A | 0.8 | B |
| Example 47 | Toner 47 | 110 | A | B | B | 0.3 | A | 2.7 | C |
| Example 48 | Toner 48 | 110 | A | B | C | 0.3 | A | 2.9 | C |
| Comparative | Comparative | 105 | A | C | D | 3.5 | D | 0.7 | B |
| Example 1 | toner 1 | | | | | | | | |
| Comparative | Comparative | 160 | D | A | A | 0.3 | A | 0.3 | A |
| Example 2 | toner 2 | | | | | | | | |
| Comparative | Comparative | 105 | A | C | D | 2.7 | C | 0.3 | A |
| Example 3 | toner 3 | | | | | | | | |

According to the present disclosure, a toner in which the low-temperature fixability, the heat-resistant storage stability, and the charging stability in both a low-temperature, low-humidity environment and a high-temperature, high-humidity environment are improved can be obtained.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-209748, filed Dec. 27, 2022, which is hereby incorporated by reference herein in its entirety.

What is claimed is:

1. A toner comprising:
toner particles containing a crystalline organic material,
wherein the crystalline organic material contains a crystalline vinyl resin as an essential component, and further contains a crystalline polyester and a wax component as optional components,
a total content of the crystalline vinyl resin, the crystalline polyester, and the wax component with respect to the toner particles is 10.0 mass % or more and 90.0 mass % or less,
the crystalline vinyl resin contains a crystalline resin A that has:
(i) units A represented by formula (1) and
(ii) units B represented by formula (2),
the toner particles contain 0.0020 mass % or more and 0.0500 mass % or less of a metal that can form a complex with an acetylacetonate moiety in a unit B of the crystalline resin A with respect to a mass of the toner particles,
the acetylacetonate moiety of at least one of the units B in the crystalline resin A forms a complex with the metal, and
in the crystalline resin A, a content of the unit B is 0.50 mass % or more and 10.0 mass % or less:
formula (1)
in formula (1), R₁ represents a hydrogen atom or a methyl group, L₁ represents a single bond, an ester bond, or an amide bond, and m represents an integer of 15 or more and 30 or less,
formula (2)
in formula (2), R₂ represents a C1-C5 alkylene group that may have a branched structure, L₂ represents a single bond, an ester bond, or an amide bond, and R₃ represents a hydrogen atom or a methyl group.

2. The toner according to claim 1, wherein a total content of the crystalline organic material with respect to the toner particles is 30.0 mass % or more and 70.0 mass % or less.

3. The toner according to claim 1, wherein a content of the unit A in the crystalline resin A is 40.0 mass % or more and 90.0 mass % or less.

4. The toner according to claim 1, wherein the metal bonded to the unit B is one of Al, Zn, Fe, Cu, Co, Ni, Ti, Mg, and Mn.

5. The toner according to claim 1, wherein the metal bonded to the unit B is aluminum.

6. The toner according to claim 1, wherein a content of the crystalline resin A in the crystalline organic material is 1.0 mass % or more and 70.0 mass % or less.

7. The toner according to claim 1, wherein the crystalline resin A has an acid value (Av) and a hydroxyl value (OHv) of 5.0 mgKOH/g or less each.

8. The toner according to claim 1, wherein the crystalline resin A has a melting point of 55.0° C. or higher and 70.0° C. or lower.

9. The toner according to claim 1, wherein the crystalline vinyl resin in the crystalline organic material contains 80.0 mass % or more of a crystalline resin B that has a weight-average molecular weight (Mw) of 5000 or more and 50000 or less, that contains 40.0 mass % or more and 90.0 mass % or less of the units A represented by formula (1), and that contains less than 0.50 mass % of the units B.

10. The toner according to claim 1, wherein the toner particles further contain an amorphous resin C,
the amorphous resin C is a styrene acrylic resin or a polyester resin,
the wax component in the crystalline organic material includes an ester wax, and
a content of the ester wax in the crystalline organic material is 70.0 mass % or more.

11. The toner according to claim 1, wherein the metal bonded to the unit B is one of Al, Zn, Fc, Co, Ti, Mg, and Mn.
